(19) United States
(12) Patent Application Publication
(10) Pub. No.: US 2020/0139516 A1
(43) Pub. Date: May 7, 2020

(54) CLAMPING DEVICE WITH EXCAVATION FUNCTION

(71) Applicant: HOMAG GmbH, Schopfloch (DE)

(72) Inventors: Martin GRINGEL, Strassberg (DE); Bernhard DOLL, Oppenau (DE)

(21) Appl. No.: 16/630,411

(22) PCT Filed: Jul. 13, 2018
(86) PCT No.: PCT/EP2018/069109

§ 371 Date: Jan. 10, 2020

(30) Foreign Application Priority Data
Jul. 14, 2017 (DE) 10 2017 115 869.3

(51) Int. Cl. B25B 11/00; B23Q 1/03; B23Q 3/06; B23Q 3/08

(52) U.S. Cl. CPC B25B 11/005; B23Q 1/035; B23Q 2703/04; B23Q 3/088; B23Q 3/062

(57) ABSTRACT

The present invention relates to a clamping device (10) and a method for clamping a workpiece (2), preferably to a machining device, in particular for clamping a workpiece (2) having one or more curved surfaces or free-form surfaces, comprising: a first receiving section (12) for receiving a workpiece (2), which preferably has at least in sections thereof a first negative form relative to the workpiece (2) to be received, a second receiving section (13) for receiving the workpiece (2), which preferably has at least in sections thereof a second negative form relative to the workpiece (2) to be received, wherein one of the receiving sections (12, 13) can be moved out of a first position relative to the other receiving section (12, 13) into a second position, and one or more clamping mechanisms (20a, 20b) is/are provided on the first receiving section (12) and/or on the second receiving section (13).

### TECHNICAL FIELD

The present invention relates to a clamping device for a machining device, in particular for clamping a workpiece having one or more curved surfaces or free-form surfaces and preferably consisting of, for example, a composite material such as fiber composite material, wood, wood-based materials or similar. Moreover, the present invention relates to a method for clamping a workpiece having one or more free-form surfaces, in particular using the clamping device according to the invention.

The device and the method according to the present invention are used in particular in the field of machining light-weight components, and in particular for machining fiber composite components on CNC machining devices. The aforementioned workpieces (light-weight components) are preferably 3D components such as car body panels, trim parts, structural components or furniture parts.

### PRIOR ART

One example of a known receiving device for a workpiece having one or more free-form surfaces is the holding device for workpieces having free-form surfaces as described in the laid-open document DE 198 02 320 A1, wherein the workpiece is clamped between dowel pins abutting the workpiece. These dowel pins are displaceably mounted in a housing and they protrude out of the housing to a greater or lesser extent. In this way, the spatial form of the workpiece can be scanned and the free ends of the dowel pins abut the spatially curved surface of the workpiece. In the case of the embodiment described, however, it is still necessary for a counter-holder to be provided, with which the workpiece is pressed against the free ends of the dowel pins and held there. With this device it is not possible to grip the received workpieces such that they can be manipulated.

The gripping and holding device described in the laid-open document DE 10 2007 020 898 A1 goes one step further in this regard. The device described comprises a housing and one or more plungers protruding from the housing, wherein the plungers are displaceably guided and have suction points on the ends thereof that protrude from the housing, which are connected to a vacuum source. The workpiece abuts the plungers, regardless of the contour or spatial form of the workpiece. In order to now be able to hold the workpiece on one side, the free ends of the plungers have suction points, with which the workpiece is held by suction.

The light-weight components described above can be produced using the RTM (Resin Transfer Molding) process. These parts have an edge region formed during the RTM process which has to be removed. Accordingly, once the workpiece has been produced using the RTM process it is necessary to carry out external contour machining or format machining. In this case it is still often necessary to carry out machining processes on the component such as boring, excavating and notching, which are advantageously carried out by machining on a CNC machining device.

With regard to the machining of light-weight components, in particular fiber composite components, a trend towards machining using special milling and boring tools on 5-axis CNC milling devices is currently emerging. The narrow-surface components that are produced as a result are often subject to particular quality standards, such as, for example, low geometric tolerances, low delamination, low conductivity and high resistance to moisture ingress into the matrix of the composite material. This often requires additional machining steps after milling, such as, for example, the use of a sealing assembly for narrow-surface sealing the components.

During the necessary milling work, high chip-removal forces occur, which can lead to the component being subject to considerable strain and deformations. For this reason, it is necessary for the workpiece receiver to safely absorb the chip-removal forces acting on the workpiece. In order to achieve a high machining quality, it is therefore necessary that the clamping device exhibits a high degree of rigidity and only a minimal tendency to vibrate.

The two clamping devices described above cannot meet these requirements since they offer too little rigidity and therefore the machining quality (tolerance compliance) is too low. In order to meet the requirement of a high degree of rigidity in particular, the use of clamping templates having a negative form of the surface of the component (outer contour or clamping surface) is proposed. These clamping templates, which are produced especially for the workpiece in question, generally comprise vacuum areas or vacuum fields distributed over the surface of the clamping template, which are supplied with a vacuum via corresponding vacuum connections, thereby facilitating an extremely stable clamping of the workpiece.

However, the clamping templates described have the disadvantage that the accessibility of the clamped workpiece for further machining steps is considerably restricted. Such machining steps, such as, for example, cleaning, milling edge finishing, quality control by measuring, sealing milling edges and the like, may for example require free space for machining the underside of the workpiece (gripping the narrow edge of the workpiece). Furthermore, considerably lower process forces (no chip-removal forces, for example) typically occur during the aforementioned finishing steps, although generally these do not have an impact on the quality of the component.

### SUBJECT MATTER OF THE INVENTION

The object of the present invention is therefore to provide a simplified, flexible and cost-effective clamping device for clamping a workpiece to a machining device, which exhibits a high degree of rigidity and a minimal tendency to vibrate or which reduces the tendency to vibrate.

Moreover, a method is provided for clamping a workpiece, in particular using the clamping device according to the invention, which also meets the requirements set out above.

The object is achieved by a clamping device for clamping a workpiece to a machining device as according to claim 1 and a method as according to claim 14. Furthermore, the present invention relates to a machining device as according to claim 17. Preferred embodiments of the invention are described in the dependent claims, wherein the subject matter of the dependent claims relating to the device(s) can be used within the scope of the method, and vice versa.

One of the ideas of the present invention is to provide a clamping device for clamping a workpiece to a machining device, comprising a first receiving section for receiving the workpiece and a second receiving section for receiving the workpiece, wherein one of the receiving sections can be moved relative to the other receiving section, in particular it can be moved relative to the other such that the first receiving section is spaced apart from the second receiving section, wherein the two receiving sections are preferably spaced apart from one another in the receiving direction of the workpiece.

The proposed clamping device has the advantage that the accessibility of the clamped workpiece can be improved, in particular the accessibility thereof during finishing.

With the proposed device and the proposed method it is possible using two receiving sections to receive and clamp a workpiece to be received for a first machining process (the main machining, for example), which is preferably carried out from above the workpiece, as a result of which the rigidity of the clamping device itself can be increased, as can the clamping forces acting on the workpiece received. It is also possible to receive and clamp the workpiece using just one receiving section for a second machining process (finishing, for example), during which lower process forces are exerted on the workpiece than in the case of the first machining process. This can improve the accessibility of the workpiece for the second machining process, in particular a finishing process. In this way, the stipulated requirements in terms of the machining quality of the workpiece as well as those in terms of accessibility can be met.

The present invention provides a clamping device for clamping a workpiece, preferably to a machining device, in particular for clamping a workpiece having one or more curved surfaces or free-form surfaces and preferably consisting at least in sections thereof of fiber composite material, the clamping device comprising: a first receiving section for receiving at least in sections thereof a workpiece, which preferably has at least in sections thereof a first negative form relative to the workpiece to be received, a second receiving section for receiving at least in sections thereof the workpiece which preferably has at least in sections thereof a second negative form relative to the workpiece to be received, wherein one of the receiving sections can be moved out of a first position (such as the receiving position) relative to the other receiving section, in particular in a receiving direction of the workpiece, into a second position (such as the finishing position) and can be moved back again, and wherein at least one of the receiving sections comprises one or more clamping mechanisms. Both the first receiving section and the second receiving section preferably comprise at least one clamping mechanism, preferably a plurality of clamping mechanisms.

It is also preferred that one of the receiving sections can be raised and/or lowered out of the first position, which is preferably a receiving position, into the second position, which is preferably a finishing position, and in particular that it can be raised and/or lowered such that a free space can be created.

The receiving position is an initial position or rest position of the clamping device. In a preferred variant, when the clamping device is used for the first time the first and second receiving sections are in the receiving position. Moreover, in a further preferred variant, provision can be made for both receiving sections to move back into the receiving position when the machining device or clamping device is disengaged. Furthermore, in the receiving position the two receiving sections are positioned, in particular positioned relative to one another, such that the two receiving sections can receive a workpiece to be machined, and in particular such that they can receive it simultaneously.

Further, within the scope of the present invention the term “negative form” is to be understood such that a certain region of the clamping device, in particular the receiving section, corresponds to a section of the workpiece to be received, i.e. it is complementary to said workpiece. Thus, if, for example, a section of the workpiece has a circular protrusion, the corresponding region of the receiving section has a correspondingly complementary recess. With the negative form, the contact surface of the receiving section is therefore formed such that it corresponds to an outer surface of the workpiece to be received.

As already indicated above, the clamping device described allows, among other things, a main machining process to be carried out in a first position, in particular a receiving position, in which the received workpiece is received and held by two or more receiving sections, wherein in the case of main machining the process forces to be absorbed are the focus, and accessibility is of secondary importance. A second position, in particular a raised or lowered position, is also provided, in which the workpiece is received and held by only one receiving section, as a result of which lower process forces can be absorbed on the one hand, but on the other hand accessibility can be improved. This is advantageous particularly in the case of finishing.

Further, a multilateral machining process, in particular a six-sided machining process, can be carried out without the need to reclamp the workpiece to be machined, which means that the machining time can be reduced and the machining quality, particularly the machining accuracy (compliance with tolerances), can be improved. Thus, with the clamping system provided with the clamping device, a very efficient machining process can be achieved since workpiece handling downtime associated with reclamping the workpiece, which is usually necessary, can be reduced to a minimum.

According to one embodiment of the present invention, the clamping device further comprises a base body on which the first receiving section is formed or removably attached, wherein the base body preferably comprises a base plate with which the base body can be attached to a machine table of a machining device or tool.

Alternatively, it is possible to mount the clamping device on a movable element such as an articulated robot, such that the machining assembly or tool can be stationary, at least during machining.

In this way, a compact, interchangeable clamping device can be created, which is particularly advantageous when a plurality of different clamping devices are required for a plurality of different workpieces. In this case the clamping device can be quickly and easily changed.

Furthermore, it is preferred that the clamping mechanisms are formed as vacuum areas and/or as suction elements, in particular as suction plates and/or suction grippers.

Within the scope of the invention it is also preferred that the first clamping mechanisms of the plurality of clamping mechanisms provided on the first receiving section can be supplied with negative pressure (vacuum) separately from the second clamping mechanisms of the plurality of clamping mechanisms provided on the second receiving section.

In this way it is possible to supply just one of the two receiving sections with negative pressure and therefore to hold and clamp the workpiece merely by means of the receiving section supplied with negative pressure.

According to a preferred embodiment of the present invention, a negative form of the first receiving section and/or the second receiving section, relative to the workpiece to be received, can be formed at least in sections thereof by the clamping mechanisms and/or a receiving profile and/or locating pins, wherein the receiving profile can preferably be formed of aluminum, plastics material or rubber (hard rubber).

Where the clamping mechanisms are formed as vacuum areas, the vacuum areas or clamping mechanisms can also take the form of a receiving profile. A receiving profile is to be understood to be a component that can receive at least one section or part of the workpiece to be received. To this end, the receiving profile may be formed from a solid material and/or may be in the form of a supporting structure, wherein the supporting structure only has certain areas that serve as receiving portions for the workpiece. Moreover, the vacuum areas and receiving profile have bore holes (suction bores) on the surface facing the workpiece, which can be supplied with negative pressure via vacuum channels. In order to now produce the negative form, the surface facing the workpiece is provided with a surface contour that is complementary to the workpiece to be received, in particular the portion of the workpiece to be received.

However, if the clamping mechanisms or some of the clamping mechanisms are formed as suction devices, in particular suction plates, it is necessary to arrange these suction devices such that they also form at least in sections thereof a negative form relative to the workpiece.

This can be advantageous particularly for the clamping mechanisms (suction elements) provided on the clamping section that is important for the finishing of the workpiece, during which the process forces that occur are generally not as strong as those that occur during the main machining of the workpiece, and therefore the fixing or clamping forces that can be achieved by the suction elements are sufficient.

Furthermore, it is preferred that the first and/or second receiving section can be moved (raised or lowered) continuously or incrementally relative to the other receiving section, wherein the first and/or second receiving section can preferably be moved in a vertical direction, perpendicular to a base plate of a base body of the clamping device.

In this way, it is possible to only move the first and/or second receiving section until a sufficient free space is created for subsequent machining, in particular for finishing. This makes it possible to avoid the first and/or second receiving section being moved unnecessarily far or spaced unnecessarily far away from the other receiving section, as a result of which an unnecessary reduction in the rigidity of the clamping device can be avoided.

According to a further modification, it is preferred that at least one further receiving section is provided, which can be moved, in particular raised and/or lowered, out of a first position (or receiving position), relative to the first and/or second receiving section, into a second position (or finishing position), and which can revert back to the first position (or receiving position), wherein the at least one further receiving section comprises one or more clamping mechanisms.

In this way, it is possible to select the receiving sections with which the workpiece is to be held in the second position (or raised or lowered position) in accordance with a required second machining process, in particular a finishing process, and the free space beneath or to the side of the held workpiece that is required for this. It is therefore possible, among other things, to first of all receive and hold the workpiece at a defined region which is not initially machined, and to carry out machining on exposed regions of the workpiece, and then subsequently to change the receiving section, as a result of which the workpiece can be machined where it was previously held.

Moreover, it is preferred that a drive and/or drives is/are provided for the first and/or second receiving section and/or the at least one further receiving section so as to facilitate the movement of the first and/or second receiving section and/or the at least one further receiving section, in particular the raising and lowering thereof.

It is also preferred that the drive or drives is/are configured in the form of a pneumatic or hydraulic lifting cylinder, an electric lifting spindle drive or a linear motor. In this way, a synchronous mechanical drive can be provided.

According to a further embodiment of the present invention, the first receiving section is arranged so as to be radially outside of the second receiving section.

Thus, the first receiving section, which is important for the first machining process (or main machining), is arranged so as to be radially outward, as a result of which the rigidity thereof, in particular in terms of bending moments, is increased. Process forces, in particular, which are exerted on the workpiece during the first machining process (or main machining), can hereby be deliberately absorbed.

Within the scope of the invention it is also preferred that a locking device is provided for the first and/or second receiving section and/or for the at least one further receiving section, in order to facilitate the locking of the first and/or second receiving section and/or the at least one further receiving section in one position, in particular in a machining position.

Owing to the locking device it is possible to fix the respective receiving section in a machining position, which may be the first position (or receiving position) and/or the second position (or finishing position), in particular in the direction of displacement. In this way, the rigidity of the clamping device can be further increased.

Furthermore, it is preferred that a vacuum source or a vacuum connection is provided, using which the one or more clamping mechanisms can be supplied with negative pressure. Moreover, a source of compressed air or a compressed air connection may be provided, which is respectively connected to a vacuum channel or a compressed air channel of a clamping mechanism. In the case of a vacuum source and a compressed air source, these can be integrated in a machine table of a machining device.

In this respect “air” means any kind of gaseous fluid.

A vacuum source can be provided by way of a device using the Venturi principle, a vacuum compressor, a rotary vane pump, membrane pump or a scroll compressor.

Negative pressure (a vacuum) is used to clamp a workpiece to a respective clamping mechanism (vacuum area and/or suction plate). Compressed air, on the other hand, is used among other things to simplify the cleaning process and/or to safely remove a workpiece from the suction plate.

The present invention also relates to a method for clamping a workpiece, preferably to a machining device, in particular for clamping a workpiece having one or more curved surfaces or free-form surfaces and preferably consisting at least in sections thereof of fiber composite material, preferably using the clamping device described above, comprising the steps of:

placing a workpiece in the region of a first and/or second receiving section, wherein the first and/or second receiving section preferably has at least in sections thereof a negative form relative to the workpiece to be received,

holding the workpiece using one or more clamping mechanisms which is/are provided on the first and/or second receiving section and is/are in contact with the workpiece,

carrying out a first machining process on the held workpiece, wherein the first machining process is preferably a main machining process,

optionally releasing the workpiece from one or more clamping mechanisms that are provided on one of the receiving sections,

moving one of the receiving sections out of a first position (the receiving position, for example) into a second position (the finishing position, for example), and

carrying out a second machining process on the held workpiece, wherein the second machining process is preferably a finishing process.

According to one embodiment of the present invention, the method described further comprises the step of:

locking the receiving section that has been moved, in particular raised or lowered, in the second, in particular raised or lowered, position, in particular by way of a positive or non-positive connection.

Furthermore, it is advantageous if with this method the workpiece is released from the one or more clamping mechanisms of one of the receiving sections prior to moving the other receiving section into the second position (the finishing position, for example).

It is also preferred that the method additionally comprises the following steps:

moving the receiving section in the second position relative to the other receiving section back into the first position, in particular the receiving position,

releasing the workpiece from the one or more clamping mechanisms that are provided on the receiving section that has been moved (raised or lowered) back (i.e. the clamping mechanism(s) not yet released), and

removing the workpiece from the receiving device.

Furthermore, the present invention relates to a machining device for machining a workpiece, in particular a workpiece having one or more curved surfaces or free-form surfaces and preferably consisting at least in sections thereof of fiber composite material, comprising a clamping device as according to one of the previous aspects.

The machining device comprises one or more machining assemblies in order to be able to machine the workpiece. The machining assembly may be a milling unit, a drilling unit, a sealing unit, or a printer such as a printer for an additive process (a so-called 3D printer), etc.

Moreover, the machining device can preferably comprise at least one unit which can be moved relative to the clamping device, in particular a cantilever, a portal or an articulated robot, and this movable unit accommodates the machining assembly.

Furthermore, it is preferable for the machining device to further comprise an attachment device, by means of which a base body of the clamping device can be attached to a machine table of the machining device, wherein the attachment device preferably comprises a supply interface with which the receiving device can be supplied with power and/or negative pressure and/or compressed air.

In this way, it is possible to provide a compact, stand-alone clamping device which can be changed quickly and easily, as already mentioned above. Changed is to be understood here to mean that a clamping device attached to a machine table can be easily released, wherein a preferred mechanical lock between the clamping device and the machine table is disengaged, and a supply interface is automatically disconnected and closed as a result of removing the clamping device from the machine table, and in the same way a new clamping device is attached and fastened to the machine table.

### BRIEF DESCRIPTION OF THE DRAWINGS

FIG. 1 shows a spatial representation of one embodiment of the clamping device according to the present invention, in which both receiving sections are formed as vacuum areas,

FIG. 2 shows a spatial representation of the clamping device shown in FIG. 1, wherein the workpiece is placed on the second receiving section,

FIG. 3 shows a sectional view of the embodiment of the clamping device according to the present invention as shown in FIG. 1 and FIG. 2, which is in the receiving position,

FIG. 4 shows a sectional view of an alternative embodiment of the clamping device according to the present invention, in which the first receiving section is formed as vacuum areas and the second receiving section is formed as suction plates,

FIG. 5 shows a sectional view of the embodiment of the clamping device as shown in

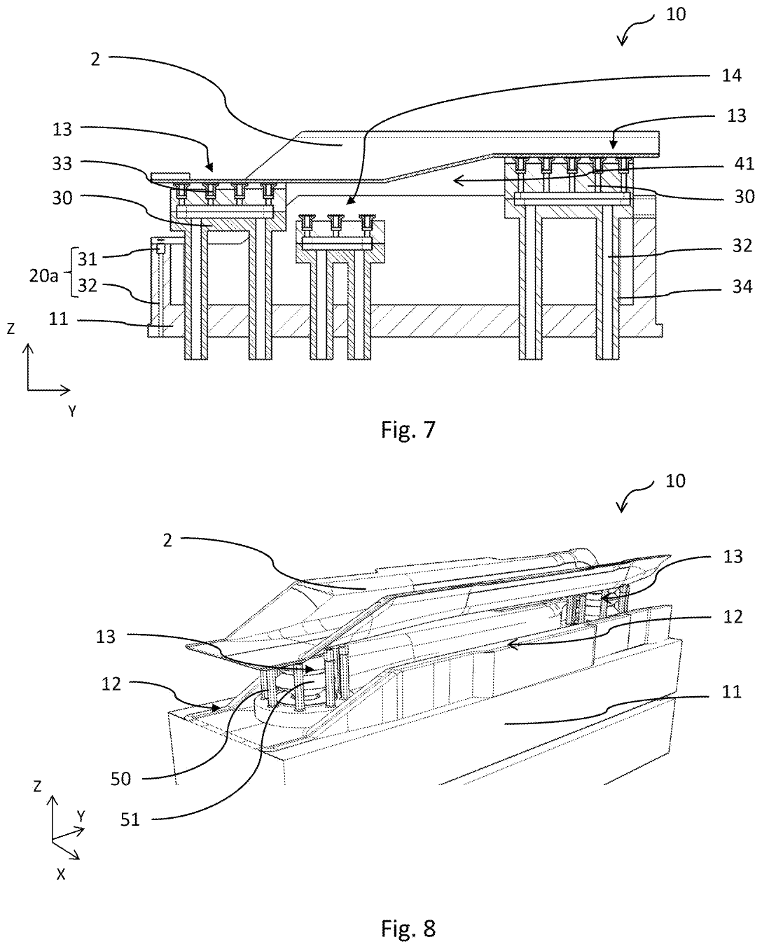

FIG. 4, wherein the clamping device is in the receiving position,

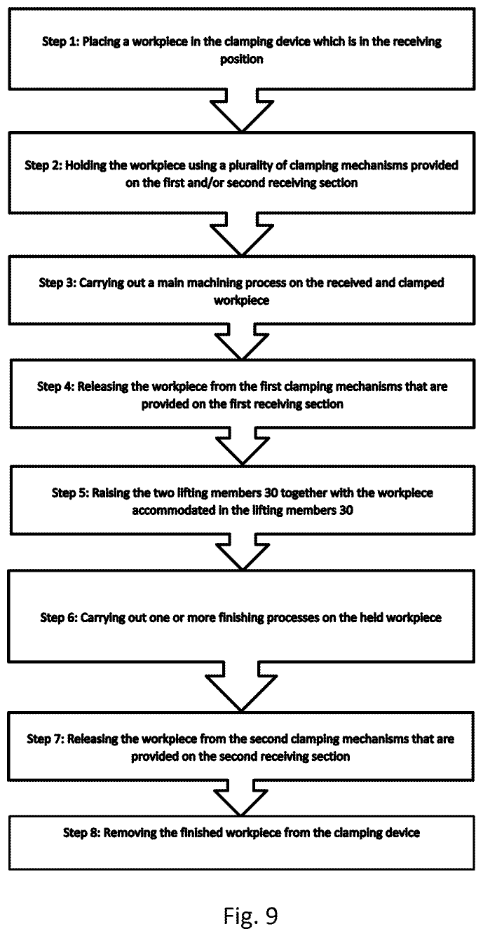

FIG. 6 shows a spatial representation of the embodiment of the clamping device as shown in FIG. 5,

FIG. 7 shows a sectional view of a further alternative embodiment of the clamping device according to the present invention,

FIG. 8 shows a spatial representation of a further embodiment of the clamping device according to the present invention, and

FIG. 9 shows a flow diagram of one embodiment of a method for clamping a workpiece having free-form surfaces as according to the present invention, preferably using the clamping device according to the invention.

### DETAILED DESCRIPTION OF THE PREFERRED EMBODIMENTS

In the following, preferred embodiments of the present invention will be described in detail on the basis of the enclosed drawings. Further modifications cited in this context of certain features can each individually be combined in order to form new embodiments.

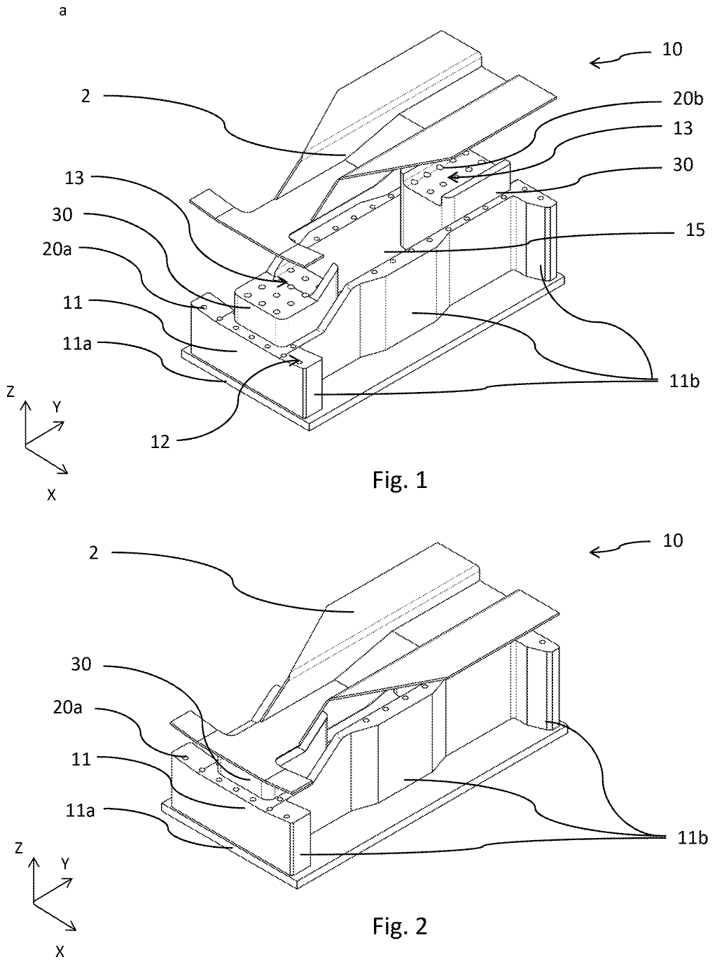

FIG. 1 shows a clamping device 10 comprising a base body 11. Within the scope of the preferred embodiment described, this is a clamping device 10 for receiving a workpiece 2 consisting of fiber composite material which has, for example, a U-shaped profile form as shown in FIG. 1. A first receiving section 12 is formed on the base body 11 which serves to facilitate the attachment of the clamping device 10 to a machine table (not shown) of a machining device. As can also be derived from FIG. 1, the first receiving section 12 faces the workpiece 2 to be received. For the sake of clarity the workpiece 2 is shown above the clamping device 10, i.e. in a state not yet received by the clamping device 10. Moreover, also for the sake of clarity the clamping device 10 shown is pictured in a raised position. This will be addressed in detail later on.

As FIG. 1 also shows, the first receiving section 12 is formed on the entire upper surface of the base body 11, although this is not strictly necessary. Furthermore, the upper surface of the base body 11 and therefore the first receiving section are designed such that they have a so-called negative form relative to the workpiece 2 to be received. To this end, the front side of the base body 11 (front left in FIG. 1) is designed to be lower than the rear side in the longitudinal direction of the base body 11, which corresponds to the longitudinal direction of the workpiece 2, and lies on the Y axis. Moreover, two central regions are formed at the two ends of the first receiving section 12, which conform in terms of the form thereof to the outer contour of the workpiece. The base body 11 also comprises widened portions 11b, which extend, for example, along the X axis and serve to widen the first receiving region 12 in order to be able to securely receive the workpiece 2 in accordance with the expansion of the workpiece 2 along the X axis.

Furthermore, the base body 11 comprises a recess 15, in which a second receiving section 13 is formed. In the recess 15, in particular in a front and rear region thereof, two lifting members 30 are accommodated. A part of the second receiving section 13 is formed on each of the upper surfaces of the two lifting members 30, which in turn face the workpiece 2 to be received. In the embodiment of the clamping device 10 shown, both receiving sections 12, 13 are formed as vacuum areas. This means that the surfaces of the base body 11 that come into contact with the workpiece 2, as well as those of the lifting members 30, are provided with bore holes 31 which can be supplied with negative pressure or a vacuum via vacuum channels 32.

The lifting members 30 also comprise a U-shaped depression on each of the upper surfaces thereof, which extends in the longitudinal direction of the base body 11. In this way, the sides of the workpiece 2 can be partially surrounded by the surfaces of the lifting members 30, as a result of which the workpiece 2 can be securely received.

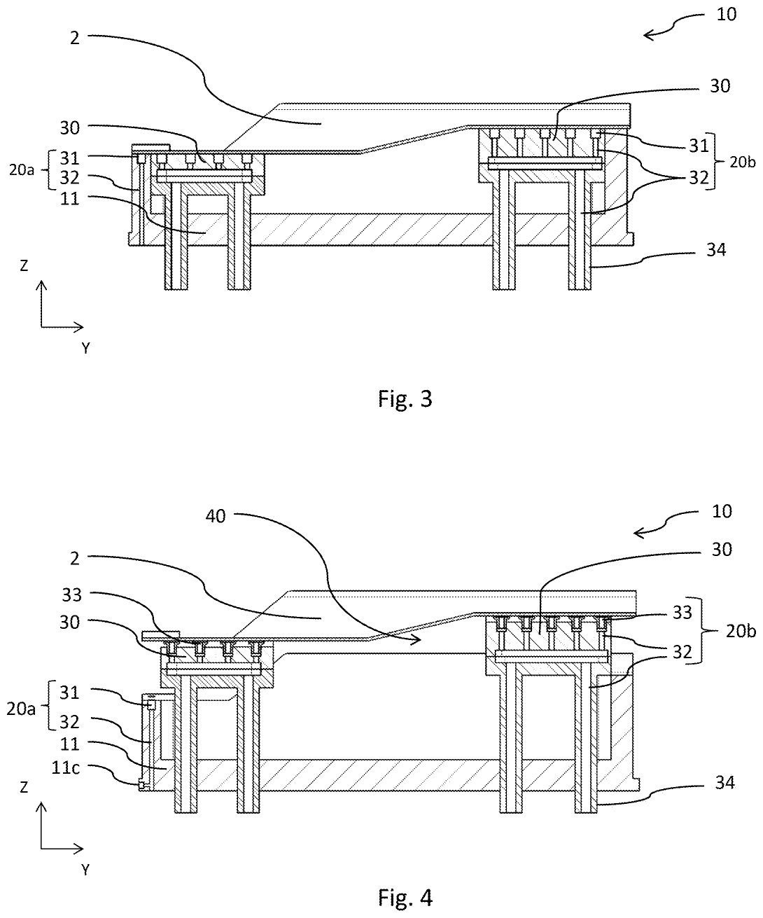

FIG. 2 shows a spatial representation of the embodiment of the clamping device 10 according to the present invention as shown in FIG. 1, wherein the workpiece 2 is placed on the second receiving section 13 and the clamping device 10 is in the raised position. As can be derived from FIG. 2, the workpiece 2 is supported to the sides thereof by the U-shape of the two lifting members 30, as a consequence of which the workpiece 2 can be securely received. As can also be derived from FIG. 2, the workpiece 2 is not lying on the first receiving section 12.

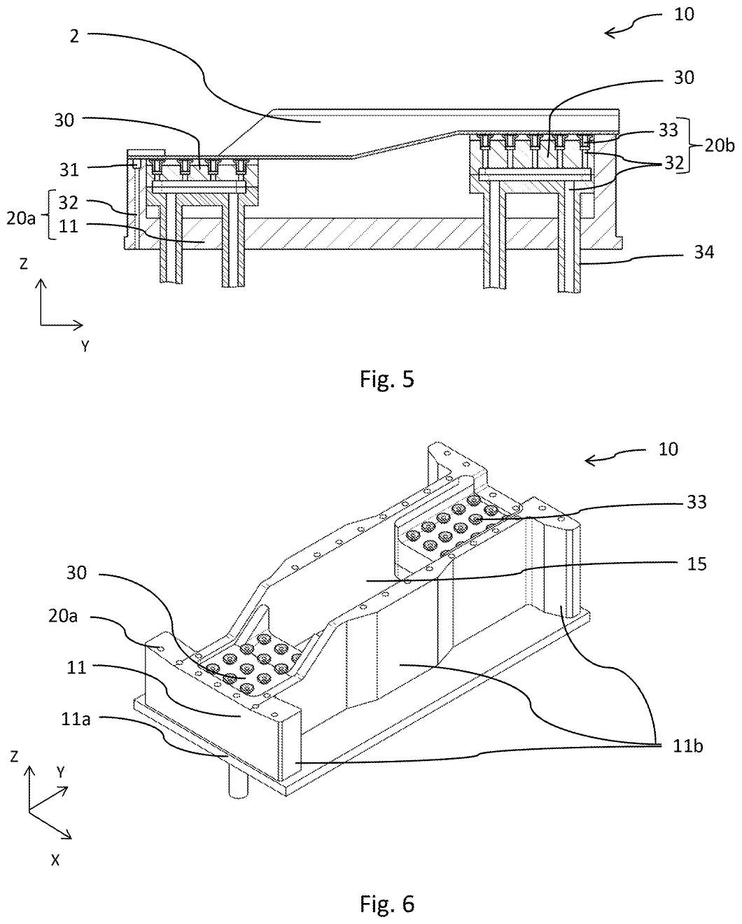

FIG. 3 shows a sectional view of the embodiments of the clamping device 10 according to the present invention as shown in FIGS. 1 and 2, which is in the receiving position here too. Contrary to FIG. 1 and FIG. 2, however, the workpiece 2 is additionally received by the first receiving section 12, as a result of which the workpiece 2 can be held more tightly by the clamping device 10, and in particular it can absorb greater process forces that may be present during the main machining of the workpiece 2. As can also be derived from FIG. 3, the two lifting members 30 each comprise two guide shafts 34, by means of which the lifting members 30 are received in the base body 11 and can be moved in the vertical direction (Z direction). The guide shafts 34 also comprise vacuum channels 32, by means of which the bore holes 31 can be supplied with negative pressure.

FIG. 4 shows a sectional view of an alternative embodiment of the clamping device 10 according to the present invention, in which the first receiving section 12 is formed as vacuum areas 20a and the second receiving section 13 is formed as suction plates 33, wherein the clamping device 10 is in a raised position in which the workpiece 2 is received and clamped only by the second receiving section 13. As is clear to see from FIG. 4, owing to the raised position it is possible to create a free space 40 beneath the received workpiece 2, and as a consequence it is possible to machine the workpiece 2 at least in part from underneath, without having to reclamp the workpiece 2.

FIG. 4 also clearly shows the bore holes 31 and the vacuum channels 32 of the vacuum regions 20a of the first receiving section 12 as well as the suction plates 33 of the second receiving section 13. As can also be derived from FIG. 4, the base body 11 is provided with a vacuum connection 11c, by means of which the vacuum regions 20a can be supplied with negative pressure. With respect to the bore holes 31 and/or the suction plates 33, it can be advantageous to be able to supply these with negative pressure separately or at least in groups. This offers the advantage that different workpieces 2 can optionally be received with the same clamping device 10, since the bore holes 31 and/or the suction plates 33, which do not come into contact with the workpiece 2 to be received, can be separated, as a result of which no unnecessary circulating air is sucked in.

Furthermore, the embodiment of the clamping mechanisms as suction plates 33 offers the advantage that greater tolerance ranges can be covered than with the embodiment as vacuum areas 20a. This means that in the case of the vacuum areas 20a, which are generally formed from materials having a low level of elasticity, there are relatively high requirements in terms of tolerance compliance/dimensional accuracy, since otherwise a vacuum cannot be formed between the workpiece 2 and vacuum area 20a, and yet this is necessary in order to suck the workpiece 2 to the vacuum area 20a, thereby fixing or clamping it thereto. By contrast, with the use of suction elements, in particular suction plates 33, these have a certain degree of plasticity or deflectability, and as a consequence the suction plates 33 can adapt to the shape of the workpiece 2. This firstly offers the advantage that the requirements made of the workpiece 2 and/or the second receiving section 13 in terms of tolerance compliance do not have to be so high, and secondly it offers the advantage that different workpieces 2 having outer contours that are at least very similar can optionally be held by the same clamping device 10. In this way it is possible to reduce the set-up time. In this regard a combination of vacuum areas 20a and suction plates 33 is also conceivable for the first receiving section 12 and/or the second receiving section 13. Thus, vacuum areas 20a could be provided in regions in which different workpieces 2 have the same outer contour, and suction plates 33 could be used in regions in which the outer contours of the individual workpieces 2 are slightly different from each other.

FIG. 5 shows a sectional view of the embodiment of the clamping device 10 shown in FIG. 4, wherein the clamping device 10 is in the receiving position. This means that the workpiece 2 is received and clamped by both receiving sections 12 and 13. Accordingly, the two lifting members 30 comprising the second receiving section 13 are lowered as compared to the raised position shown in FIG. 4, and therefore they are brought into the receiving position. In the receiving position, surfaces of the lifting members 30 are at approximately the same height as the surface of the base body 11, as a result of which the component to be received can be received simultaneously by both receiving sections 12, 13, and can be clamped by all of the clamping mechanisms (vacuum areas 20a and suction plates 33) that come into contact with the workpiece 2. In this way a maximum clamping force can be exerted on the workpiece 2, and therefore the greatest process forces can be absorbed by the clamping device 10.

FIG. 6 shows a spatial representation of the embodiment of the clamping device 10 according to the present invention as shown in FIG. 5, wherein the workpiece 2 is not shown. FIG. 6 reveals the individual suction plates 33 of the second receiving section 13, which are attached to the upper surface of the two lifting cylinders 30, as well as the vacuum regions 20a, in particular the bore holes 31 of the vacuum regions 20a, of the first receiving section 12.

FIG. 7 shows a sectional view of a further alternative embodiment of the clamping device 10 according to the present invention, wherein a third lifting member 30 is provided, and a third receiving section 14 is provided on the surface thereof. In the embodiment shown, the third receiving section 14 also comprises suction plates 33. As can also be derived from FIG. 7, the third main body 30 is positioned so as to be slightly below the other two lifting members 30. This means that in the state shown, only the two lifting members 30 already known are in contact with the workpiece 2, or in particular the suction plates 33 thereof, while the third receiving section 14, and in particular the suction plates 33 thereof, is not in contact with the workpiece 2. Accordingly, a free space 41 is created between the third receiving section 14 and the workpiece 2, which facilitates the machining of the workpiece 2 from underneath. If the workpiece is now to be machined in the region of the underside thereof, for which it was previously held by the second receiving section 13, the workpiece 2 can first of all be received and clamped by the third receiving section 13 and subsequently, for example, the contact between the front (shown on the left in FIG. 7) second receiving section 13 and the workpiece can be broken and the front-most lifting member 30 (shown on the left in FIG. 7) can be lowered.

Furthermore, FIG. 8 shows a spatial representation of a further embodiment of the clamping device 10 according to the present invention. As can be derived from FIG. 8, the clamping device 10 according to the embodiment shown comprises a base body 11, on the upper surface of which a negative form is formed, corresponding to the contour of the workpiece 2 to be received, wherein the negative form forms a first receiving section 12. As can also be derived from FIG. 8, two second receiving sections 13 are provided, which take the form of two separate clamping units that are accommodated in the base body 11.

The two clamping units each comprise a plurality of locating pins 50, which are arranged in a circle around a suction device 51, in particular a suction gripper, wherein the suction device 51 is arranged in the center of the locating pins 50. The locating pins 50 are configured to be able to scan and therefore replicate the outer contour of the workpiece 2 to be received. In this way it is possible to form a negative form of the workpiece 2 using the locating pins 50. Once the negative form has been formed by the locating pins 50 these can be fixed in place.

In order for a workpiece 2 to be able to be received and clamped by the clamping units, once the workpiece 2 has been put in place a negative pressure is applied to the suction device 51, in particular the suction gripper, which is in contact with the workpiece 2, as a result of which the workpiece 2 is sucked and pressed against the locating pins 50. In this way it is possible to clamp and therefore to fix the workpiece 2 into the two clamping units.

FIG. 8 shows by way of example the clamping device 10 in the finishing position. This means that the first receiving section 12, which is formed on the base body 11, and the two second receiving sections 13, which are formed by the two clamping units, are spaced apart from one another, in particular in the vertical direction. In this regard it is advantageous if the base body 11 can be lowered out of the receiving position (first position) into the finishing position (second position), i.e. if the first receiving section 12 can be lowered downwards. In this way it is possible to create a free space underneath the workpiece 2 for finishing, without having to move the workpiece 2. This is particularly advantageous with respect to machining tolerances.

FIG. 9 shows a flow diagram of one embodiment of a method for clamping a workpiece having curved surfaces or free-form surfaces as according to the present invention, preferably using the clamping device according to the invention.

In step 1, a workpiece 2 to be machined is placed into the clamping device 10 which is in the receiving position. This means that the workpiece 2 is brought into contact with the first receiving section 12 and the second receiving section 13, in particular with the clamping mechanisms 20a, 20b of the two receiving sections 12, 13.

In step 2, a vacuum is applied to the plurality of clamping mechanisms 20a, 20b provided on the first and second receiving sections, as a result of which negative pressure is built up between the clamping mechanisms 20a, 20b and the workpiece 2 and therefore the workpiece 2 is held.

In the subsequent step, step 3, the main machining can then be carried out on the workpiece 2 that has been received and clamped. Main machining is to be understood here to be machining or a machining process during which maximum process forces can be exerted on the workpiece 2. This means that the workpiece 2 has to be held extremely well and securely in the clamping device 10, and this can be ensured by the holding force of the two receiving sections 12 and 13. The main machining may be, among other things, machining, in particular milling, boring, grinding or sawing.

Once the main machining is complete, the workpiece 2 is released from the first clamping mechanisms 20a of the first receiving section 12 in step 4. To this end the supply of the first clamping mechanisms 20a with negative pressure is stopped. A compressed air device may optionally be provided, which accelerates the release of the vacuum.

Once the workpiece 2 has been released from the first clamping mechanisms 20a, in step 5 the two lifting members 30 of the clamping device 10 are raised, in particular into a desired raised position. The workpiece 2, which is still accommodated and clamped in the second receiving section 13, is thereby brought into a raised position, as a result of which a free space can be created beneath and optionally to the side of the workpiece 2.

In step 6 the finishing of the workpiece 2 can then be carried out. If desired, a plurality of finishing processes different from one another can also be carried out. Finishing is to be understood here to be a machining process during which lower process forces are exerted on the workpiece 2 than are exerted during the main machining. For this reason, in spite of a reduced holding force provided by just the second receiving section, the workpiece 2 can be held and fixed in a satisfactory manner.

The finishing process may be, for example, deburring, grinding, buffing, sealing, varnishing and the like.

In accordance with the description of FIG. 7, the second receiving section 13 may if necessary be partially replaced by the third receiving section 14 in order to create a free space beneath or to the side at a different part of the workpiece 2.

In step 7, once all the finishing processes have been completed, the workpiece 2 is released from the second clamping mechanisms 20b of the second receiving section by the vacuum also being released, as has already been described with respect to step 4.

Once the vacuum between the workpiece 2 and the second clamping mechanisms 20b has been completely released, the finished workpiece 2 can in step 8 be removed from the clamping device 10 and the clamping device 10 can optionally be brought back into the receiving position.

1. A clamping device for clamping a workpiece for clamping a workpiece having one or more curved surfaces or free-form surfaces, to a machining device, comprising:
a first receiving section for receiving at least in sections thereof a workpiece having at least in sections thereof a first negative form relative to the workpiece to be received,
a second receiving section for receiving at least in sections thereof the workpiece having at least in sections thereof a second negative form relative to the workpiece to be received,
wherein one of the receiving sections can be moved out of a first position relative to the other receiving section into a second position, and
wherein at least one of the receiving sections comprises one or more clamping mechanisms.

2. The clamping device according to claim 1, wherein one receiving section can be raised and/or lowered out of the first position, which is preferably a receiving position, into the second position, which is preferably a finishing position, in particular it can be raised and/or lowered such that a free space can be created.

3. The clamping device according to claim 1, further comprising a base body on which the first receiving section is formed or removably attached, wherein the base body preferably comprises a base plate with which the base body can be attached to a machine table of a machining device.

4. The clamping device according to claim 1, wherein the clamping mechanisms are formed as a vacuum area and/or as a suction element.

5. The clamping device according to claim 1, wherein a first clamping mechanisms, which are provided on the first receiving section, can be supplied with negative pressure separately from a second clamping mechanism, which are provided on the second receiving section.

6. The clamping device according to claim 1, wherein a negative form of the first receiving section and/or the second receiving section, relative to the workpiece to be received, is formed at least in sections thereof by the clamping mechanisms and/or a receiving profile and/or locating pins, wherein the receiving profile is preferably formed of aluminum, plastics material or rubber.

7. The clamping device according to claim 1, wherein the first and/or the second receiving section can be moved continuously or incrementally relative to the other receiving section, wherein the first and/or second receiving section can be moved in a vertical direction, perpendicular to a base plate of a base body of the clamping device.

8. The clamping device according to claim 1, further comprising at least one further receiving section, which can be moved out of a first position relative to the first and/or second receiving section into a second position, wherein the at least one further receiving section comprises one or more clamping mechanisms.

9. The clamping device according to claim 1, wherein a drive and/or drives is/are provided for the first and/or second receiving section and/or the at least one further receiving section so as to facilitate the movement of the first and/or second receiving section and/or the at least one further receiving section.

10. The clamping device according to claim 9, wherein the drive or drives is/are configured in the form of a pneumatic or hydraulic lifting cylinder, an electric lifting spindle drive or a linear motor.

11. The clamping device according to claim 1, wherein the first receiving section is arranged so as to be radially outside of the second receiving section.

12. The clamping device according to claim 1, further comprising a locking device for the first and/or second receiving section and/or for the at least one further receiving section, so as to facilitate the locking of the first and/or second receiving section and/or the at least one further receiving section in one position.

13. The clamping device according to claim 1, further comprising a vacuum source or a vacuum connection, by means of which the one or more clamping mechanisms can be supplied with negative pressure.

14. A method for clamping a workpiece having one or more curved surfaces or free-form surfaces, using the clamping device according to claim 1, comprising the steps of:
placing a workpiece in the region of a first and/or second receiving section, wherein the first and/or second receiving section each having at least in sections thereof a negative form relative to the workpiece to be received,
holding the workpiece using one or more clamping mechanisms which is/are provided on the first and/or second receiving section and is/are in contact with the workpiece,
carrying out a first machining process on the held workpiece, wherein the first machining process is a main machining process,
moving one of the receiving sections out of a first position into a second position, and
carrying out a second machining process on the held workpiece, wherein the second machining process is a finishing process.

15. The method according to claim 14, further comprising the step of:
locking the receiving, section that has been moved in the second position by way of a positive or non-positive connection.

16. The method according to claim 14, wherein prior to the movement of one of the receiving sections being moved into the second position, the workpiece is released by the one or more clamping mechanisms of the other receiving section, and wherein the method comprises the further steps of:
relatively moving the receiving section in the second position back into the first position
releasing the workpiece from the one or more clamping mechanisms that are provided on the receiving section that has been moved back, and
removing the workpiece from the receiving device.

17. A machining device for machining a workpiece having one or more curved surfaces or free-form surfaces, comprising a clamping device according to claim 1 and a machining assembly, for machining the workpiece, wherein the machining device further comprises: a unit that is movable relative to the clamping device wherein the movable unit accommodates the machining assembly.

18. The machining device according to claim 17, further comprising: an attachment device, by means of which a base body of the clamping device can be attached to a machine table of the machining device, wherein the attachment device comprises a supply interface with which the receiving device can be supplied with power and/or negative pressure and/or compressed air.
